(19) United States
(12) Patent Application Publication
(10) Pub. No.: US 2014/0245657 A1
(43) Pub. Date: Sep. 4, 2014

(54) Flying insect killing device

(71) Applicant: Phillip Graham Kirschbaum, Petaluma, CA (US)

(72) Inventor: Phillip Graham Kirschbaum, Petaluma, CA (US)

(21) Appl. No.: 13/987,700

(22) Filed: Aug. 22, 2013

Related U.S. Application Data
(63) Continuation-in-part of application No. 13/066,558, filed on Apr. 19, 2011, now abandoned.

(51) Int. Cl. A01M 3/00

(52) U.S. Cl. CPC A01M 3/00
USPC 43/135

(57) ABSTRACT

An insect killing device including rigid outer and inner tubes assembled to be slidably and telescopically engaged, and having a pliant, limber elastic cord extended therethrough. The cord is interconnected at its respective proximal and distal ends only to a gripping pull knob and substantially flat insect-impact element. The pull knob is connected to the inner tube proximal end and is larger than the outer tube's inner diameter to prevent accidental disassembly thereof. Sighting an insect on a surface, user grasps the outer tube by one hand, and with the other hand retracts the knob along with the inner tube and cord, drawing the impact element toward the inner tube distal end. On release the stretched cord and inner tube drive the impact element against the insect. The pliant nature of the cord affords an unrestricted twisting motion of the impact element so as to align with an impact surface.

### CROSS REFERENCE TO RELATED APPLICATIONS

This application is a continuation-in-part of, and claims the benefit of priority under 35 U.S.C. 120 for U.S. non-provisional patent application Ser. No. 13/066,558, filed Apr. 19, 2011, entitled Fly Killing Device, the entire contents of which are incorporated herein by reference.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND

1. Technology Field

The present disclosure relates generally to the field of insect control and eradication. More specifically, the disclosed invention embodiment concerns manually operated insect killing utensils, tools, implements, devices and the like such as fly swatters constructed for terminating individual insects, primarily of the flying type.

2. Related Art

Fly swatters of various shapes and sizes have been used by people for hundreds of years to rid themselves and their living areas of annoying and potentially harmful flying insects such as the common housefly, mosquito, wasp, or hornet. Such swatters most often consist of an elongate handle terminating at a distal end with an interconnection to a flat, semi-rigid sheet-like striking member. The user, observing a resting insect, grasps a first (proximal) end of the elongate handle and, with a pivoting arm motion or wrist snap, rapidly swings the sheet-like member toward the insect. Over the years, alternatives to the ubiquitous fly swatter have been developed.

For example, Martin Belokin's U.S. Pat. No. 4,386,478 (M. Belokin '478) and Paul Belokin's published US patent application 2009/0293853 (P. Belokin '853) present retrievable self-contained projectiles launched from simulated handguns by coil springs included in the projectiles.

A much earlier simulated handgun device for insect killing was introduced by Funk in U.S. Pat. No. 1,499,168 (Funk '168). Funk's patent, entitled “Insect Catcher,” illustrates a barrel-mounted coil-spring which drives an elongated wire toward the insect. A first (proximal) end of the wire is deformed into a trigger latch; a second (distal) end thereof terminates in a coiled portion directly attached to a wire mesh for impacting insects. The coil portion is described as flexible so as to permit the mesh to fully hit a surface at almost any angle.

The above-mentioned insect killing devices suffer certain deficiencies rendering the devices generally ineffective. Discharged projectiles lack dependable accuracy; they are noisy in release and time-consuming in loading and projectile retrieval/re-load. Despite assertions to the contrary, their insect killer discs and wire meshes are not fabricated to afford unrestrained capacity to instantly alter the angle of impact of the killing surface relative to a wall or other surface whereon an insect is resting—or at least as efficiently as implied. Their resilience must be overcome before altering impact angle. Besides, simulated handgun devices with multiple interactive mechanical parts are noisy to operate and relatively expensive to manufacture, particularly as compared to more simplistic insect swatters referenced above, and the present disclosure discussed in detail herebelow.

### BRIEF SUMMARY OF DISCLOSURE

An object of the present invention, to be fully understood from the following embodiment disclosure, is to provide an easily deployable insect killing device that is not only reliable, but reusable and inexpensive. Accordingly disclosed in detail herebelow is a unique structural organization including a pair of telescoping (inner/outer) generally concentric tubes and a pliant and limber elastic cord extended therethrough. The elastic cord is aligned with, and interconnected at its respective proximal and distal ends only to a gripping pull knob and substantially flat impact element. When the device is at rest, the elastic cord is purposefully constructed with a constant, slight axial tension. This slight tension ensures organizational integrity of the device parts, and affords a head-start for rapidly gaining firing tension.

Operationally, the disclosed insect killing device discharges with a simple pull and subsequent release of the pull knob. Upon release of the gripping pull knob, the impact element is impelled by force of the elastic cord and inner concentric tube along a guided trajectory toward a flying insect at rest on a wall or other surface. The pull knob is sized to prevent the inner tube from passing entirely through (thus escaping) the outer tube.

If the insect killing device trajectory encounters a wall or other surface at an incidence angle less than 90-degrees, the limber cord easily yields to permit instant twisting of the impact element to achieve surface to surface killing contact. The disclosed embodiment is configured for ever-ready deployment. Discharge is torque-free and rapid yet relatively silent so as not to issue a warning signal to the insect. Repeated discharge is convenient as it requires no projectile retrieval, re-loads or latching steps.

### BRIEF DESCRIPTION OF DRAWINGS

Other features and advantages of the invention will become more readily understood from the following detailed description taken in connection with the appended claims and attached drawings in which:

FIG. 1 is a side perspective view of a flying insect killing device embodiment in the ready-to-use position and wielded by a user;

FIG. 2 is a side perspective view of the flying insect killing device and user (of FIG. 1) depicted immediately after the device has been used;

FIG. 3 is a cross-sectional side elevation view of a flying insect killing device embodiment similar to that of FIGS. 1 and 2, depicted in ready-to-use position.

FIG. 4 is a cross-sectional view similar to FIG. 3, depicting the flying insect killing device embodiment immediately following its successful use.

The above-referenced drawing figures are incorporated into and form part of the specification to illustrate an exemplary embodiment of the present invention. Throughout the drawings, like reference numerals designate corresponding elements. The figures are not to scale but are intended to disclose the inventive concepts by illustration. These drawings, together with the detailed description, serve to explain the principles of the invention, as well as how the invention can be assembled and used. It will be recognized that the principals of the invention may be embodied in a variety of forms.

### DETAILED DESCRIPTION

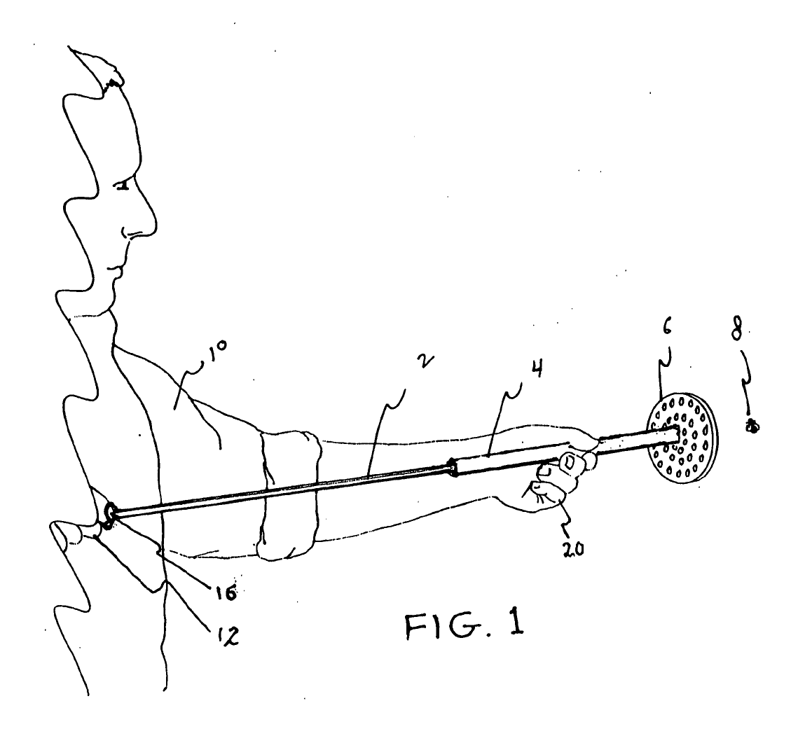

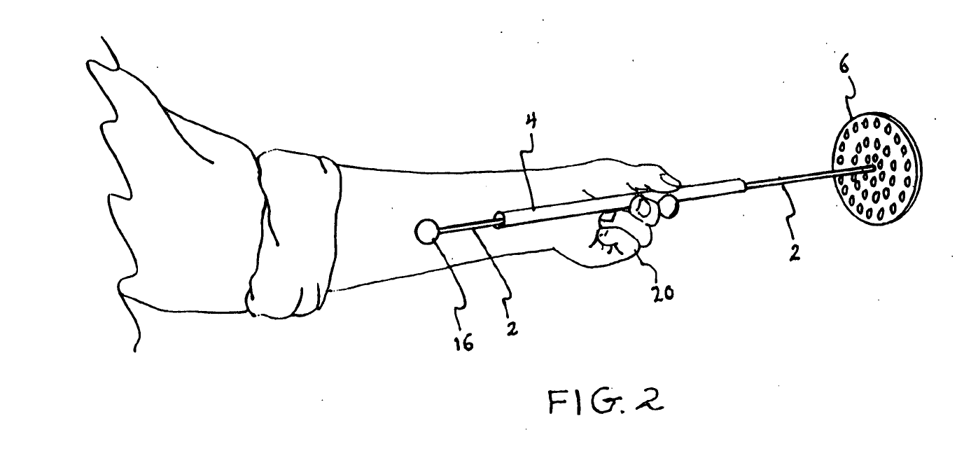

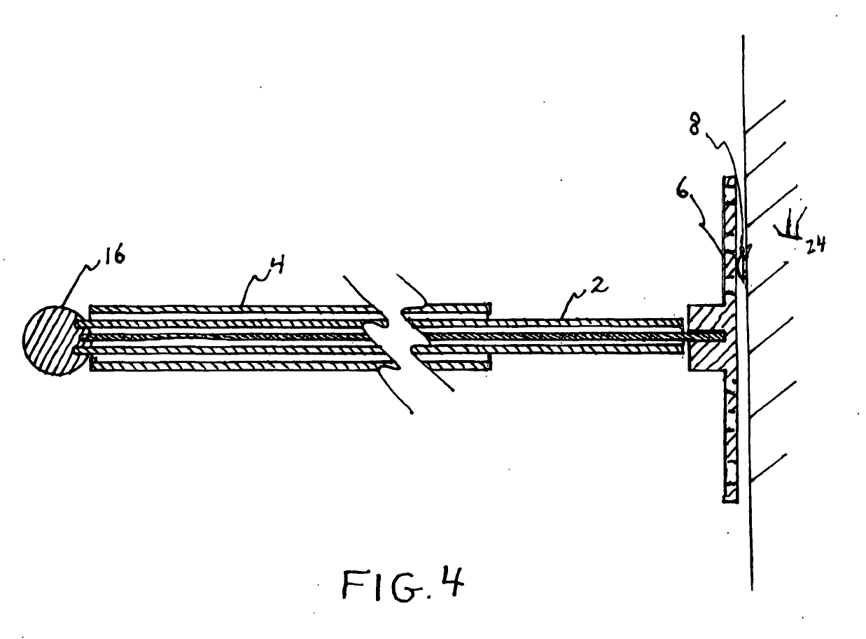

Referring now to disclosure embodiment FIG. 1, a perspective view of insect killing device 1 is shown in ready-to-use mode. The presently disclosed embodiment of the insect killing device 1 includes a limited number of essential elements, namely: generally concentric tubes including a rigid outer tube 4 of a finite length and inner diameter, and a rigid inner tube 2 of finite length and outer diameter; outer tube 4 inner diameter is greater than inner tube 2 outer diameter; the finite length of outer tube 4 is substantially shorter than the finite length of said inner tube 2; a gripping pull knob 16 (viewable in FIGS. 2 and 4) affixed to a proximal end of inner tube 2, and greater in size than said outer tube 4 inner diameter (so as to prevent knob 16 from slipping through rigid outer tube 4 resulting in disassembly of the device 1); a pliant and limber elastic cord 14 extending through said rigid inner tube 2; said cord 14 attached at its proximal end to said gripping pull knob 16 and, at its distal end, generally centrally attached (only) to a substantially flat impact element 6.

Said cord 14 may advantageously be attached in slightly tensioned mode between pull knob 16 and impact element 6. As will become apparent from review of other drawing figures, outer tube 4 is not directly fastened to any other element of the insect killing device 1, though its movement is limited by pull knob 16 and disc 6.

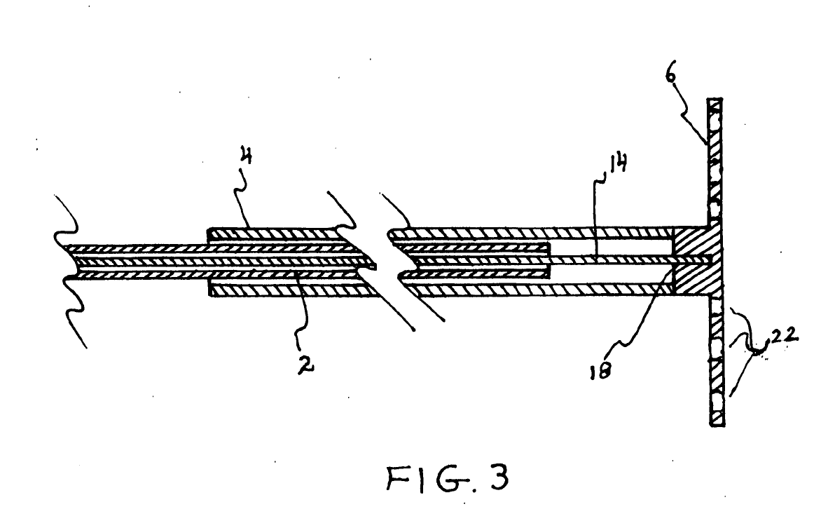

Dramatically depicted in FIG. 1, user 10 has grasped rigid outer tube 4 with one hand 20 so as to guide insect killing device 1 into firing position. While steadying tube 4, user 10 is seen to be pulling (or drawing) back on pull knob 16 with a second hand 12. Since rigid inner tube 2 and a proximal end of cord 14 (see FIGS. 3 and 4), are fixedly attached to said knob, these elements retract therewith as movement of impact element 6 is restricted by a distal end of outer tube 4, further tensioning cord 14. With the steadying advantage of a two-hand grip, user 10 (as seen in FIG. 1) has aimed the insect killing device 1 so that the flexible impact element 6, and all its associated parts 16, 2, 4, and 14 are in line with flying insect 8 depicted (in FIG. 4) at rest on a wall surface 24.

Though not limited as such, and merely as an example, impact element 6 is herein depicted as disc-shaped, but certainly could take on a number of shapes, regular or irregular. Insect killing device 1, at rest, is configured such that elastic cord 14 is preferably maintained in a slightly tensioned, extended condition. This “static tension” state affords two important advantages. Purposely establishing a slight pre-tensioned state in cord 14 ensures that: (a) insect killing device 1 retains its assembled composure when not in use; (b) effort and time required in fully extending elastic cord 14 upon firing the device 1 will be minimal, as slack in the cord 14 has been eliminated by pre-tensioning.

Though not apparent in FIG. 1, user 10 has caused the elastic cord 14 to stretch considerably by pulling back on pull knob 16 (see FIG. 3 depiction). When user 10 releases pull knob 16 (see FIGS. 2 and 4), inner tube 2 is caused to rapidly thrust forwardly as elastic memory forcefully returns cord 14 to its initial slightly tensioned condition. The thrusting inner tube 2 distal end carries therewith the flexible impact element 6, shown in FIG. 4 as having impacted an insect 8.

The impact element 6 is driven forward with considerable accuracy since the inner tube 2 and its axially stretched elastic cord 14 are restricted in true trajectory at all times by outer tube 4 as shown in FIGS. 2-4. Importantly, since the substantially flat impact element 6 is joined to the rest of flying insect killing device 1 only via a distal end of pliant and limber elastic cord 14, the element 6 enjoys considerable freedom of angular (lateral twisting or pivoting) movement on impact.

In other words, impact element 6 can be discharged toward a target surface (e.g., wall 24 whereon insect 8 rests), and at an angle of incidence less than 90-degrees relative said target surface 24. On initial contact with said target surface 24, the limber elastic cord 14 instantly flexes such that the substantially flat element 6 turns to impact substantially flat against surface 24. This flexibility considerably increases the chances of successfully impacting an insect 8 resting on said wall 24.

The instant lateral twist resulting from the combination of the impact element 6 interconnecting with laterally pliant, limber cord 14 is particularly important when distinguishing the present invention with respect to prior technologies which propose coiled wire or soft plastic and the like. Such materials may be, to some degree, flexible but they have inherent deformation recovery qualities, wholly different from pliant or limber elements without lateral resistance.

FIG. 3 shows a partial side section view of the invention which longitudinally bisects the inner tube 2, the outer tube 4 and the elastic cord 14 while in the ready to use position. In this view, as well as FIG. 4, flexible impact element 6 optionally includes a generally central hub 18 (optional) to which cord 14 is fixedly attached. This view shows the inner tube 2 drawn back so that the shoulder hub 18 of the impact element is intimately engaged with the end surface of outer tube 4.

Elastic cord 14, being one of the key functional elements of the device 1 must exhibit sufficient strength and elastic memory to rapidly propel the impact element 6 forward when pull knob 16 is released, and must perform dependably in a great number of repetitions. Apertures 22 in impact element 6 are optionally provided to reduce air resistance as impact element 6 travels forward.

FIG. 4 shows a view of the flying insect killing device 1 in vertical section depicted immediately following its use. Shown in vertical cross-section are gripping pull knob 16, rigid inner and outer tubes 2, 4 and elastic cord 14. At the moment depicted, impact element 6 has been propelled forward by force of cord 14 in memory recovery, so that the substantially flat surface of element 6 has squashed insect 8 on wall 24.

Gripping pull knob 16 is purposely designed as larger than the diameter of outer tube 4 so as to avoid pull knob 16 accidentally slipping through outer tube 4 during use. This further ensures that the insect killing device 1 remains ready for re-use when necessary, rather than having to be reassembled after having slipped apart.

The presently disclosed insect killing device 1 is fully expected to be far less expensive and operationally-challenged than typical simulated gun devices and flying disc launchers (discussed above). Compared to the ubiquitous fly swatter, insect killing device 1 is competitively priced and considerably more accurate.

By way of example only (and in no way intended as limiting the scope of appended claims), outer tube 4 may be fabricated to be approximately seventeen inches in length. Inner tube 2 may be approximately twenty-nine inches long. This will allow the user 10 to pull the inner tube 2 back approximately thirteen inches, leaving around four inches of the inner tube 2 inside outer tube 4 thereby retaining its slidable telescoping integrity. This overlap in structure is important in maintaining stability of device 1, ensuring user 10 marksmanship upon aiming and discharge. Elastic cord 14 may be approximately one-eighth inch thick, depending of course on the nature or qualities of the elastic and its tensile limits. As noted hereabove, the cord is a principal part of the structural organization and must deliver dependably high-performance in repetitive use over a relatively long period of time. Again, these dimensions are merely examples for illustrative purposes only and are representative of a vast number of possibilities.

While the invention has been described in connection with a preferred embodiment, the foregoing description is not intended to limit the scope of the invention to the particular form set forth. On the contrary, it is intended to embrace such alternatives, modifications, and equivalents as may be included within the spirit and scope of the invention as defined by the appended claims.

I claim:

1. An insect killing device comprising:
a substantially flat insect impact element;
a rigid outer tube having an inner diameter;
a rigid inner tube substantially longer than said outer tube;
a pliant elastic cord with a proximal and a distal end, said cord slidably engaged within said inner tube;
a pull knob larger than said outer tube inner diameter to prevent movement of said knob through said outer tube;
said rigid inner tube slidably and telescopically engaged within said outer tube, and fixedly attached at one end thereof to said pull knob;
the plaint elastic cord interconnected by its proximal end only to said pull knob and by its distal end only to said substantially flat insect impact element;
whereby pulling said knob stretches said cord, retracting said inner tube and impact element and, upon pull knob release, said pliant elastic cord contracts rapidly causing said rigid inner tube and said impact element to discharge forward to kill an insect, while said pliant elastic cord affords unrestricted twisting of said impact element so as to conform to an impact surface.

2. An insect killing device as set forth in claim 1 wherein said substantially flat impact includes a plurality of apertures to reduce air resistance when said device is discharged.

3. An insect killing device as set forth in claim 1 wherein said pliant elastic cord is in a slightly tensioned condition when at rest within said rigid inner tube.

4. An insect killing device as set forth in claim 1 wherein said impact element is a disc and said pliant elastic cord is attached directly and generally centrally thereto.

5. An insect killing device as set forth in claim 4 wherein said disc includes a generally central hub.
